(19) United States
(12) Patent Application Publication
(10) Pub. No.: US 2009/0273126 A1
(43) Pub. Date: Nov. 5, 2009

(54) Method and Apparatus of Gas-Assisted Injection Molding of Thick Parts

(75) Inventor: Kevin C. Scott, Suamico, WI (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: Krueger International, Inc., Green Bay, WI (US)

(21) Appl. No.: 12/500,878

(22) Filed: Jul. 10, 2009

Related U.S. Application Data
(62) Division of application No. 12/113,711, filed on May 1, 2008.

(51) Int. Cl. B29C 45/18

(52) U.S. Cl. 264/572

(57) ABSTRACT

Gas-assisted injection molding is used to form molded parts having relatively thick cross-sections, such as a support section of a chair back and seat portion of a chair. Gas is injected into a mold cavity using the same nozzle and screw injector that injects molten resin into the mold cavity. The injected gas creates a void in the molten resin that allows a reduced amount of resin to be used to fill a mold cavity without sacrificing the integrity of the molded part.

### BACKGROUND AND SUMMARY OF THE INVENTION

The present invention relates generally to a method of forming relatively thick parts using gas-assisted injection molding.

Injection molding is a process whereby a heated resin or plastic is injected into a mold, typically by either a reciprocating screw or a ram injector. Once in the mold, the heated resin is allowed to cool and thus solidify. Gas-Assisted Injection Molding (GAIM) is an injection molding process whereby gas is injected into to the mold as the heated resin cools. One of the benefits of GAIM is it that allows a reduced amount of resin to be used. More particularly, part of the volume defined by the mold, commonly referred to as the mold cavity, is partially filled with gas that is trapped as the resin cools and solidifies. Smaller and thinner plastic parts are commonly formed using GAIM but it is generally difficult to form a thicker plastic part, such as a part having a thickness in excess of one inch, with a GAIM process.

Generally, during the injection molding process, the heated resin begins to cool as the resin comes into contact with the cooler interior surfaces of the mold. For thinner parts, it is generally possible to fill the mold with the heated resin before the resin cools and solidifies. However, for thicker parts, the heated resin begins to cool before the mold cavity is filled. The resin however does not cool evenly throughout the mold cavity, which can result in the cooled resin presenting an uneven or contoured surface or base for the heated resin as it is continues to be injected into the mold. This can result in cosmetic defects being formed in the part. In addition, the uneven surface presents issues with injecting the gas properly.

It is therefore an object of the invention to provide a GAIM process capable of molding parts having a thickness in excess of one inch.

It is another object of the invention to provide a part, such as molded chair back and seat for a chair, having a thickness greater than one inch and formed using a GAIM process.

Various other features, objects and advantages of the invention will be made apparent from the following description taken together with the drawings.

### BRIEF DESCRIPTION OF THE DRAWINGS

The drawings illustrate the best mode presently contemplated of carrying out the invention.

In the drawings:

FIG. 1 is a schematic view of a gas-assisted injection molding machine;

FIG. 2 is a schematic view of an injection screw for use with the machine of FIG. 1 and having an elongated hole formed in the screw that allows gas to be passed through the screw;

FIG. 3 is an isometric view of a mold usable with the machine of FIG. 1 for making a part with a thick section, such as a seat and chair back portion of a chair;

FIG. 4 is an isometric view of the mold of FIG. 3 with the mold sections separated from one another showing the mold cavity defined by the mold sections;

FIG. 5 is a section view of the mold of FIG. 3 taken along line 5-5 of FIG. 3;

FIG. 6 is a section view of the mold of FIG. 3 taken along line 6-6 of FIG. 3;

FIG. 7 is an isometric view of a thick section part, such as a chair back and seat portion of a chair, that may be formed using the gas-assisted injection molding machine of FIG. 1 and the mold of FIG. 3;

FIG. 8 is a section view of the chair back and seat portion of FIG. 7 taken along line 8-8 of FIG. 7 showing a thick support section formed using gas-assisted injection molding according to one embodiment of the present invention; and

FIG. 9 is a flow chart setting forth the steps of an exemplary gas-assisted injection molding process for making the chair back and seat portion of a chair shown in FIGS. 7 and 8.

### DETAILED DESCRIPTION OF THE INVENTION

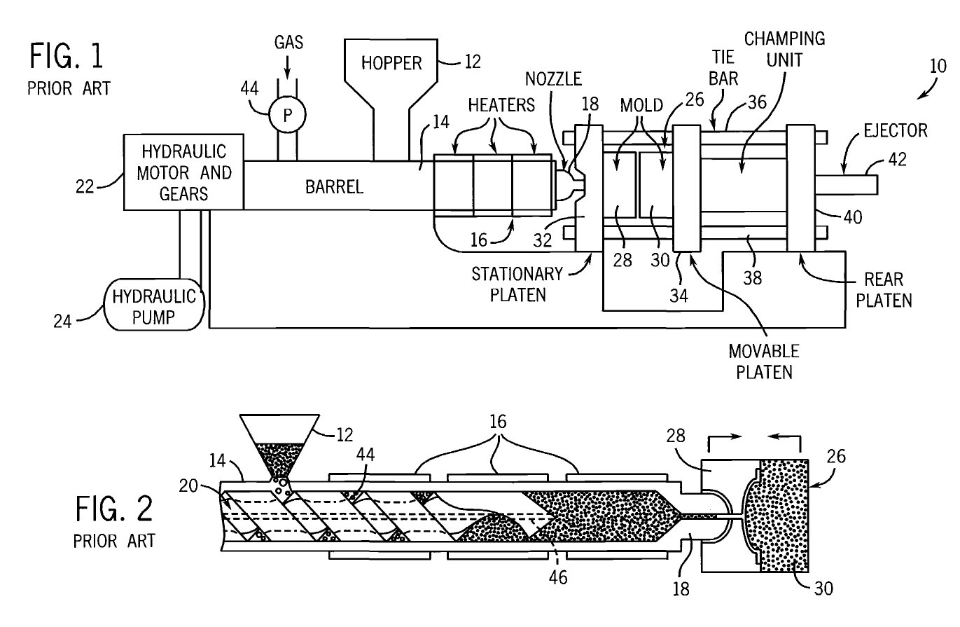

A gas-assisted injection molding machine is shown in FIG. 1. The machine 10 includes a reservoir or hopper 12 from which resin or other plastic material is fed to an injection barrel 14. Generally, the resin is fed into the barrel 14 under the force of gravity, but is contemplated that the resin could be pumped into the barrel 14. The barrel 14 extends through a heater assembly 16 that heats the resin. The resin is injected through a nozzle 18 by a screw injector 20, shown in FIG. 2, which is reciprocated within the barrel 14 by a hydraulic gear and motor assembly 22, to which hydraulic fluid is fed by a hydraulic pump 24.

The mold 26 includes a pair of mold sections 28, 30. Mold section 28 is held by a stationary platen 32 whereas mold section 30 is held by a movable platen 34. The platens 32, 34 are connected to a pair of tie bars 36, 38. The movable mold section 30 is moved into contact with and away from the stationary mold section 28 by a clamping unit 40 connected to the movable platen 34. The clamping unit 40 is also connected to the tie bars 36, 34. An ejector 42 ejects the formed part once the molding process is complete.

The machine 10 further includes a gas supply 44 that supplies gas, under pressure, to the barrel 14 and through the screw injector 20, which has a threaded body 44 and an elongated hole 46 formed along the body 44. The elongated hole 46 allows gas to be presented to the nozzle 18 and ultimately the mold 28 from the gas supply 44 though the screw injector 20 during a gas-assisted injection molding process.

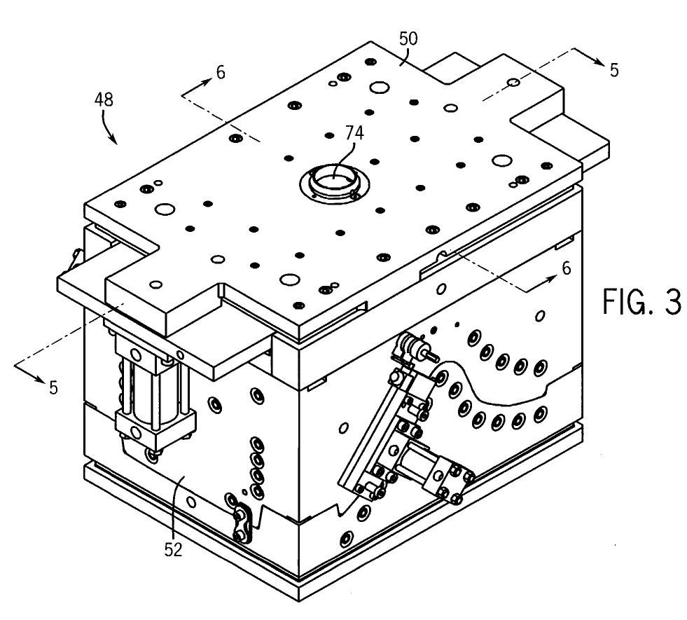

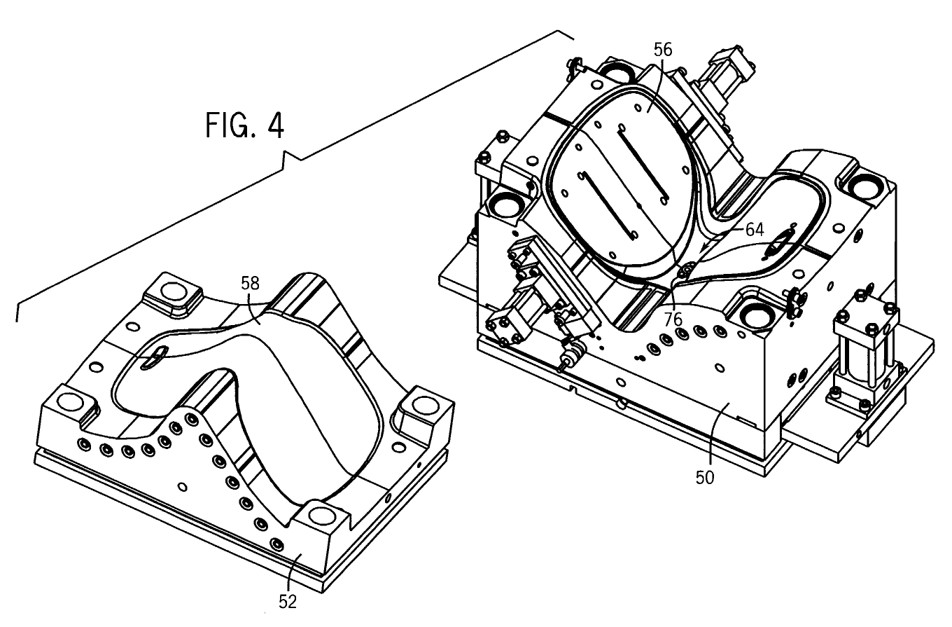

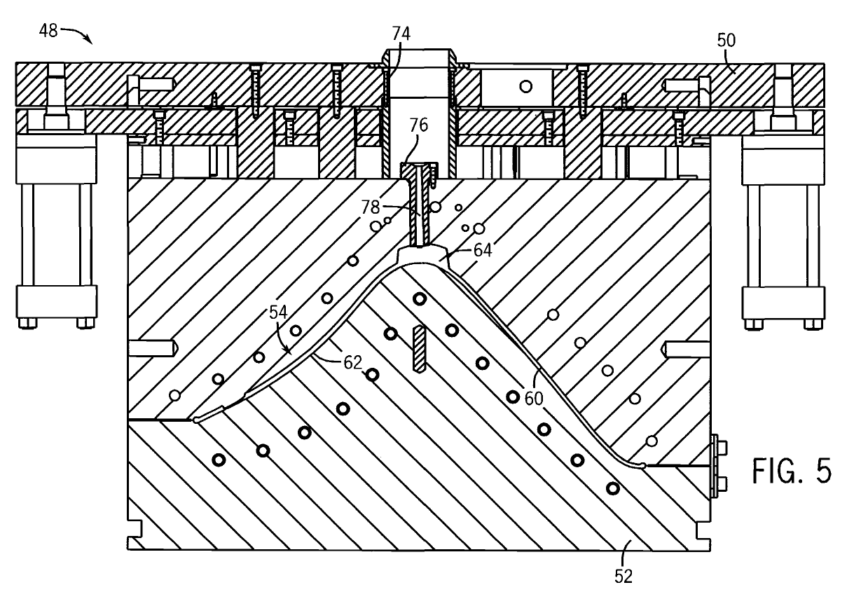

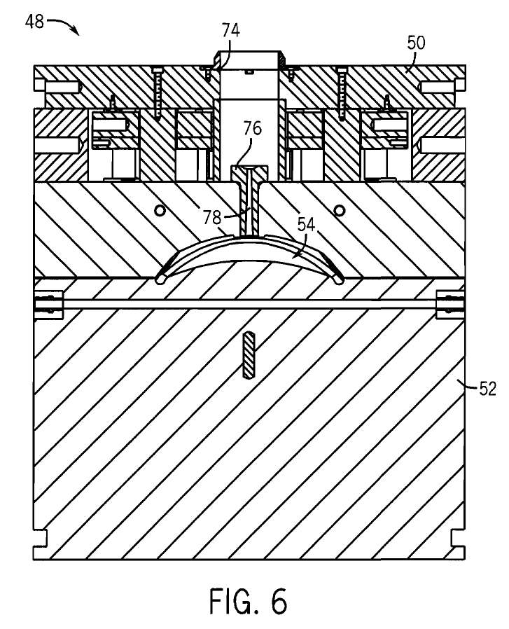

The machine 10 can be used with various types of molds to form different types of injection molded products. One exemplary type of product is the chair back and seat sections of a chair. A mold 48 for molding such chair back and seat sections is shown in FIGS. 3-6; although, it is contemplated that the invention may be used to mold other types of parts, including those having thick sections as well as thin sections. In the orientation shown in the figures, the mold 48 has an upper mold section 50 and a lower mold section 52. The mold sections 50, 52 collectively define a mold cavity 54, shown in FIGS. 5 and 6. In particular, an undersurface 56 of the mold section 50 and the upper surface 58 of mold section 52 cooperate to define the mold cavity 54 when the mold sections 50, 52 are clamped together. The mold cavity 54 generally defines a seat section 60 and a chair back section 62, as shown in FIG. 5. The seat section 60 and the chair back section 62 intersect at a recessed section 64.

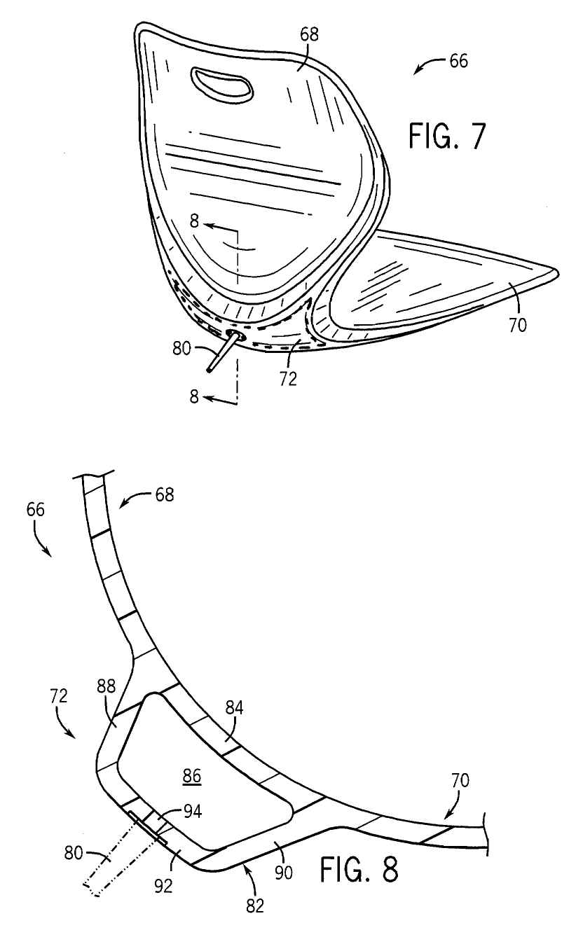

Referring briefly to FIG. 7, the mold 48 is used to form the chair back and seat portions of a chair shell 66, designated by reference numerals 68 and 70, respectively. The recessed section 64 is used to mold a support portion 72 defined at the backside of the chair 66. The support portion 72 is integrally formed with the chair back and seat portions 68 and 70, respectively; yet, is thicker than the back and seat portions.

Referring back to FIGS. 3, 5 and 6, the mold 48 includes a port 74 along which the nozzle 18 of the barrel 14 is aligned. The screw injector 20 may be inserted into the port 74 to force molten resin into the mold cavity. In one representative embodiment, the mold 48 includes a sprue 76 that extends from the recessed section 64 of the mold cavity 54 and provides a passage 78 from port 74 to the mold cavity 54. During the injection molding process, molten resin is forced by the screw injector 20 into the mold cavity through the sprue 76. Before gas is injected into the mold cavity, the screw injector 20 is translated into abutment with the sprue 76 and with the elongated hole 46 aligned with passage 78. It is recognized however that gas could be injected with the screw injector 20 spaced from the sprue 76.

Referring again to FIG. 7, which shows a molded chair back portion 68 and a seat portion 70 of a chair 66, a molded sprue 80 is formed extending from the backside of support section 72 during the molding process. The molded sprue 80 is formed as a result of molten resin filling the mold sprue 76, cooling and then solidifying. After the molded chair 66 is ejected from the mold 48 the molded sprue 80 is removed, such as by a cutting device (not shown) and the hole formed in the support portion 72 is plugged using a suitable plug. For instance, a piece of hardened plastic could be sonic welded to the support portion 72 to plug the hole.

As shown in FIG. 8, the support portion 72 generally includes a thickened body 82 extending from a curved surface 84 that seamlessly joins the seat portion 70 and the chair back portion 68 of the chair 66. As will be explained in greater detail below, after heated resin is injected into the mold 48, gas is injected into the mold 48. The gas forces the heated resin outwardly against the mold surfaces 56 and 58 that define the mold cavity 54. The heated resin cools and solidifies while the gas is being injected resulting in a void 86 being formed in the thickened body 82. More particularly, the gas forces the heated resin against the inside surfaces of the mold thereby forming walls 88, 90, and 92, seamlessly connected to one another that collectively define void 86. As shown in FIG. 8, the molded sprue 80 extends from wall 92 that is generally parallel with curved surface 84. As noted above, when the molded sprue 80 is removed, e.g., cut, a hole 94 is formed in the wall 92

It will be appreciated that the thickness of the support portion 72 is considerably thicker than the chair back and seat portions 68 and 70, respectively. In one embodiment, the thickness of the support portion 72 is approximately two inches as defined from wall 92 to curved wall 84.

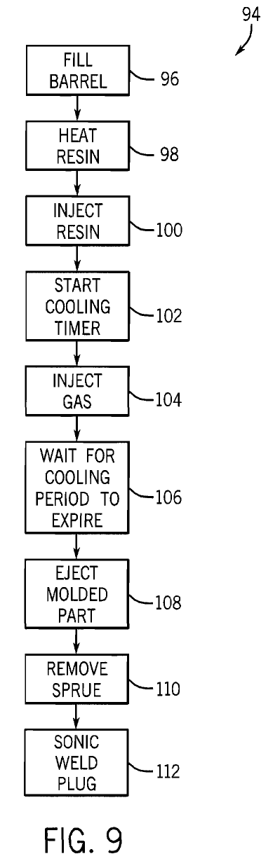

The steps of an exemplary GAIM process 94 are set forth in FIG. 9. In setting forth the steps of the process 94, reference will also be made to the components of the machine 10 shown in FIGS. 1-2. After the machine 10 has been properly set up and mold 48 has been loaded into the machine 10, the process 94 begins with the filling of the barrel 14 at block 96. The amount of resin loaded into the barrel 94 is a function of the size of the part to be molded. For example, for a chair back and seat, with a thickened support, as described with respect to FIGS. 7-8, the barrel is loaded with approximately 12.0 cubic inches of resin from hopper 12. The amount of resin loaded into the barrel 14 is commonly referred to as the “shot size”.

Once the barrel 14 is loaded, the resin is heated by heaters 16 at block 98. In one embodiment, the heaters 16 include five heating elements that are heated approximately to 425, 425, 415, 410, and 400 degrees Fahrenheit, respectively. After the resin is heated, the heated resin is injected into the mold cavity 54 at block 100. In one embodiment, the resin is injected under a pressure of approximately 800 psi at approximately 1.5 inches per second for a fill time of approximately 12.0 seconds.

After the resin has been loaded into the mold cavity 54, a cooling timer is started at block 102. In one embodiment, the cooling timer is set to approximately 75 seconds to correspond to a resin cooling time of approximately 75 seconds. Gas is then injected into the mold cavity at block 104 following a predefined delay period. In one embodiment, the gas injection is commenced after an approximate 12 second delay and is injected for approximately 40 seconds at a pressure of approximately 750 psi. As described above, the gas forces the molten resin outwardly against the interior mold surfaces 56, 58 to form a void 86.

After the gas is injected, the resin is allowed to cool, which in one embodiment, corresponds to approximately 11 seconds after cessation of gas injection. After the molded resin has cooled and thus solidified for the predefined cooling period, the molded resin is ejected from the mold 48 at block 108. The molding process results in a molded sprue 80 being formed which is removed at block 110 resulting in the hole 94 being formed that is filled by sonic welding a plug thereto at block 112.

It can thus be appreciated that the sprue 80 is formed when the gas is injected into the mold cavity after the molten resin has been injected into the mold cavity 54. Thus, the sprue 80 has an open end facing the gas injection nozzle, and a passage that extends from the open end completely through sprue 80 and into communication with the void 86 that is formed in support portion 72.

The present invention thus contemplates a gas assist injection molding process which has been found to be suitable for molding significantly thicker parts than has been possible in the prior art. The system and process of the present invention allows gas assist injection molding of a thick part in a central location on the thick part, in which the void area to be occupied by the gas extends outwardly in all directions from the injection location. The sequence of steps carried out in accordance with the present invention provides a part that does not warp or shrink, which has typically been the case when attempting to injection mold thick parts using a gas assist process.

It is understood that the values set forth above are merely representative and that other values may be used for other types of molded parts. Additionally, the values set forth above may fall within a range of suitable values for gas-assisted injection molding of a given part.

Various alternatives and embodiments are contemplated as being within the scope of the following claims particularly pointing out and distinctly claiming the subject matter regarded as the invention.

1. A method of forming a thick part formed of plastic material, comprising:
injecting molten resin through a nozzle into a mold cavity for a period between 10-15 seconds, the mold cavity defined by an interior surface; and
injecting gas into the mold cavity for a period between 30-50 seconds to press the molten resin against the mold surface, wherein the injected gas functions to form a void area in the part.

2. The method of claim 1 wherein the molten resin is injected for a period of approximately 12 seconds.

3. The method of claim 1 wherein the gas is injected for a period of approximately 40 seconds to form a void in the injected molten resin.

4. The method of claim 1 further comprising waiting a period between 10-15 seconds after commencement of molten resin injection into the mold cavity before injecting the gas into the mold cavity.

5. The method of claim 4 wherein the gas is not injected until after a delay time of approximately 12 seconds.

6. The method of claim 1 further comprising injecting the gas at a gas pressure between 700-800 psi.

7. The method of claim 6 wherein the gas pressure is approximately 800 psi.

8. The method of claim 1 further comprising injecting the molten resin with a pressure between 750-850 psi.

9. The method of claim 8 wherein the molten resin is injected at a pressure of 800 psi.

10. The method of claim 1 wherein the gas is injected into the mold cavity through the nozzle.

11. The method of claim 1 wherein the mold cavity defines a part having a thickness between 1-3 inches.

12. The method of claim 11 wherein the thickness is approximately 2 inches.

13. The method of claim 11 wherein the part formed is that of a seat and chair back portion of a chair.

14.-18. (canceled)
